(19) United States
(12) Patent Application Publication
(10) Pub. No.: US 2002/0104243 A1
(43) Pub. Date: Aug. 8, 2002

(54) Sign

(76) Inventor: Marvin M. Barber, Abbotsford (CA)

Correspondence Address: LONG AND CAMERON, SUITE 1401 - 1166 ALBERNI STREET, VANCOUVER, BC, V6E 3Z3, CA

(21) Appl. No.: 09/773,611

(22) Filed: Feb. 2, 2001

(51) Int. Cl. G09F 15/00; G09F 7/02

(52) U.S. Cl. 40/607; 40/611; 248/158

(57) ABSTRACT

A sign comprising a length of metal rod bent at a lower end thereof to provide a ground or soil penetration tip, an intermediate portion extending vertically upwardly from the tip. An angled portion extending upwardly from and at an angle to the intermediate portion and a top end portion extending substantially horizontally from an upper end of the angled portion, the sign further comprising a signboard and the signboard having a horizontal top edge and a horizontally extending opening in the vicinity of the top edge, the top end portion extending along the opening and the top end portion including a bent portion intermediate opposite ends thereof, such that the opposite ends and the bent portion functionally engage the signboard at locations which are diametrically opposite and longitudinally spaced relative to the top end portion.

### BACKGROUND OF THE INVENTION

1. Field of the Invention

The present invention relates to signs and is useful in particular, but not exclusively, for horticultural signs intended, for example, to display horticultural information at garden centers, and for yard signs.

2. Description of the Related Art

It has previously been proposed to provide a sign in the form of a sign holder comprising a stake-like vertically elongate portion with a pointed lower end, which is intended to be driven into the ground or into soil in a container for supporting the sign.

It is, however, a disadvantage of such prior art signs that they are relatively complicated and expensive to manufacture.

### BRIEF SUMMARY OF THE INVENTION

It is accordingly and object of the present invention to provide a novel and improved sign which can be manufactured very simply and inexpensively.

According to the present invention a sign comprises a length of metal rod bent at a lower end thereof to provide a ground or soil penetration tip, a vertical portion extending vertically upwardly from the tip, a further portion extending upwardly from and at an angle to the vertical portion and a top end portion extending substantially horizontally from an upper end of the further portion, the sign further comprising a signboard and the signboard having a horizontal top edge and a horizontally extending opening in the vicinity of the top edge, the top end portion extending along the opening and the top end portion including a bent portion intermediate opposite ends thereof, such that the opposite ends and the bent portion frictionally engage the signboard at locations which are diagrammatically opposite and longitudinally spaced relative to the top end portion.

In a preferred embodiment of the invention, the signboard comprises a sheet or panel of corrugated cardboard or the like, which may be plastic coating to protect it from the elements, and is therefore very inexpensive and simple to produce. Since the metal rod is also inexpensive and can be simply and inexpensively bent into shape, the entire sign can be produced at very low cost.

The bent portion of the top end portion, by its frictional engagement with the signboard, effectively resists removal of the signboard from the metal rod as a result, for example, of wind, and also resists flapping of the signboard around the top end portion of the metal rod in response to wind.

The ground or soil penetration tip is preferably diamond-shaped, in order to secure the sign firmly in position in the ground or soil, in use, and to effectively resist uprooting of the sign from the soil or ground by the effect of wind.

### BRIEF DESCRIPTION OF THE DRAWINGS

The invention will be more readily understood from the following description thereof taken in conjunction with the accompanying drawings, in which:

FIG. 1 shows a view of perspective of a sign according to a first embodiment of the present invention in an assembled position;

FIG. 2 shows a broken-away view of the sign of FIG. 1 during assembly of the sign;

FIG. 3 shows a view in front elevation, partly broken-away in vertical cross-section along, of a signboard forming part of the sign of FIGS. 1 and 2;

FIG. 4 shows a view in cross-section along line 4-4 of FIG. 3; and

FIG. 5 shows a view in perspective of a modification of a metal rod forming part of the sign of FIGS. 1 through 4.

### DESCRIPTION OF THE PREFERRED EMBODIMENTS

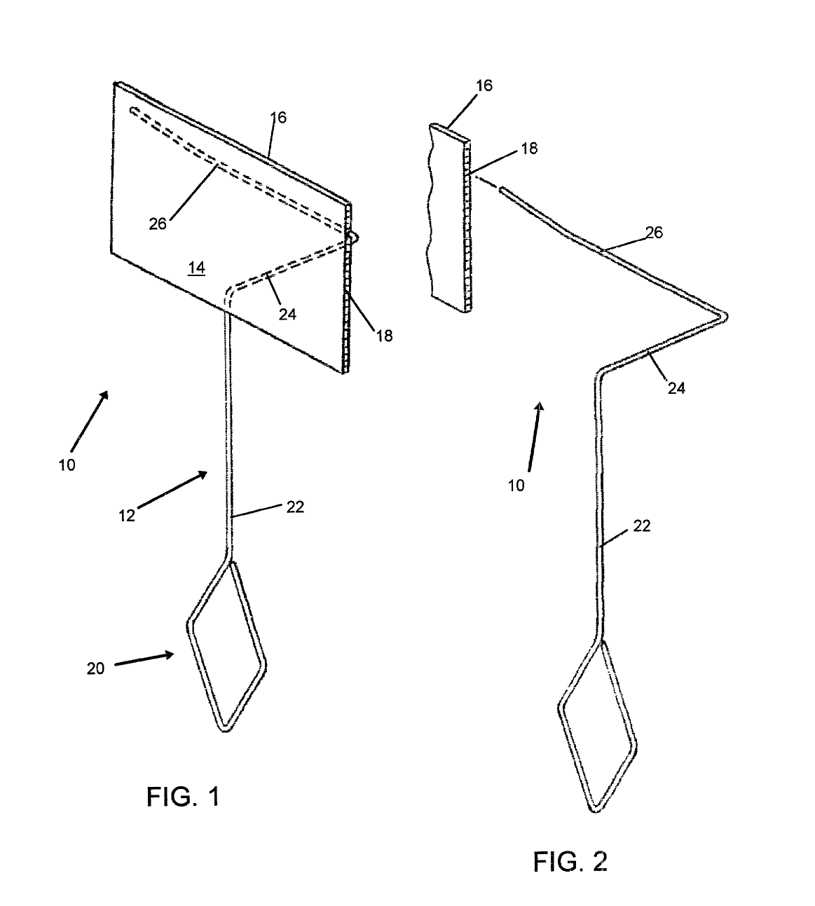

FIGS. 1 through 4 show a sign which is indicated generally by reference numeral 10 and which is formed of two components, namely a metal rod indicated generally by reference numeral 12 and a signboard 14.

The sign board 14 is made of plastic-coated corrugated cardboard and is of a rectangular shape, having a horizontal upper edge 16 and a plurality of through openings 18 which also extend horizontally, i.e. parallel to the upper edge 16.

The metal rod 12 is bent into a diamond shape at its lower end to form a ground or soil penetration tip indicated generally by reference numeral 20.

A straight vertical portion 22 extends upwardly from the tip 20 to an a further portion 24, which extends upwardly and at an angle to the vertical portion 22.

A top end portion 26 extends in a generally horizontal direction from the upper end of the further portion 24 through one of the through openings 18 in the signboard 14.

The top end portion 26 has opposite ends 28 and 30 and a bent portion 32 between the opposite ends 28 and 30. In the illustrated embodiment of the invention, the bent portion 32 is bent downwardly relative to the opposite ends 28 and 30. However, bending in another direction may alternatively be employed.

The top end portion 26, the further portion 24, the vertical portion 22 and the tip 20 are preferably coplanar, so that the entire metal rod 12 is flat and, therefore, can be conveniently and compactly packed for storage and transportation.

The bent portion 32 of the top end portion 26 of the of the rod 12 facilitates effectively secure retention of the signboard 14 on the top end portion 26 so as to counteract the effects of wind acting on the signboard 14 and tending to cause the signboard 14 to tilt around the top end portion 26 or even to become displaced longitudinally of the top end portion 26.

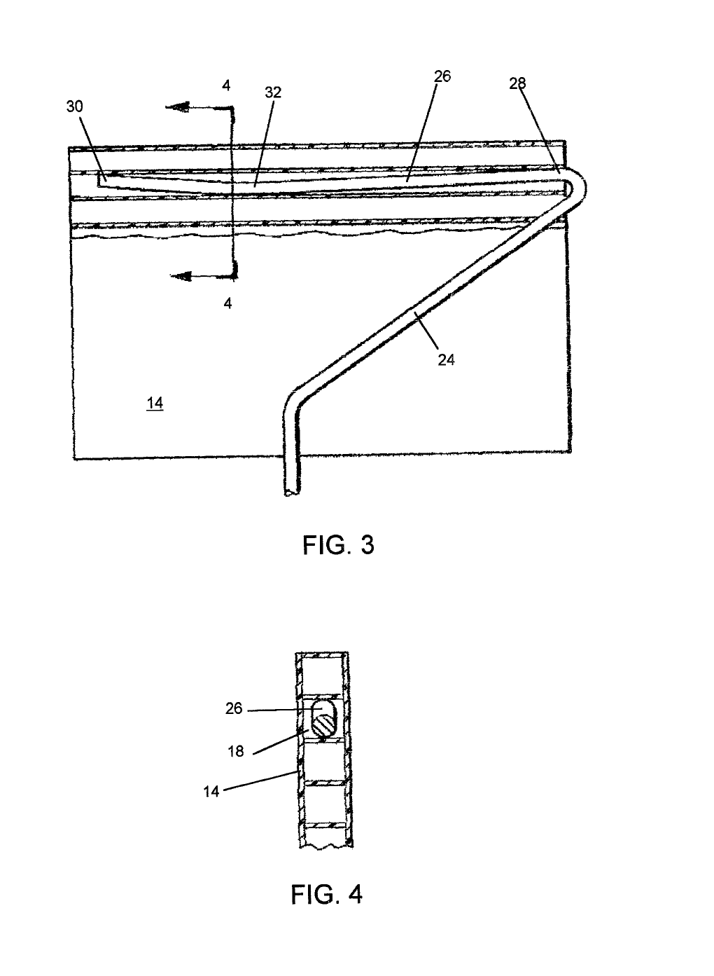

More particularly, as shown in FIG. 3, the opposite ends 28 and 30 of the top end portion 26 frictionally engage the top of a wall 34 defining the opening 18 into which the top end portion 26 is inserted, while the bent portion 32 frictionally engages the bottom of the wall 34. Consequently, the top end portion 26 is in frictional engagement with the wall 34 at locations which are diagrammatically opposite and longitudinally spaced relative to the top end portion 26.

In this way, the signboard 14 is effectively retained in tight frictional engagement with the top end portion 14 so as to effectively resist displacement of the signboard 14 relative to the top end portion 26.

The diamond shape of the tip 20 effectively resists movement of the tip 20 relative to the ground or soil into which the tip 20 penetrates during use of the sign 10, so as to resist disturbance of the sign 10 by wind.

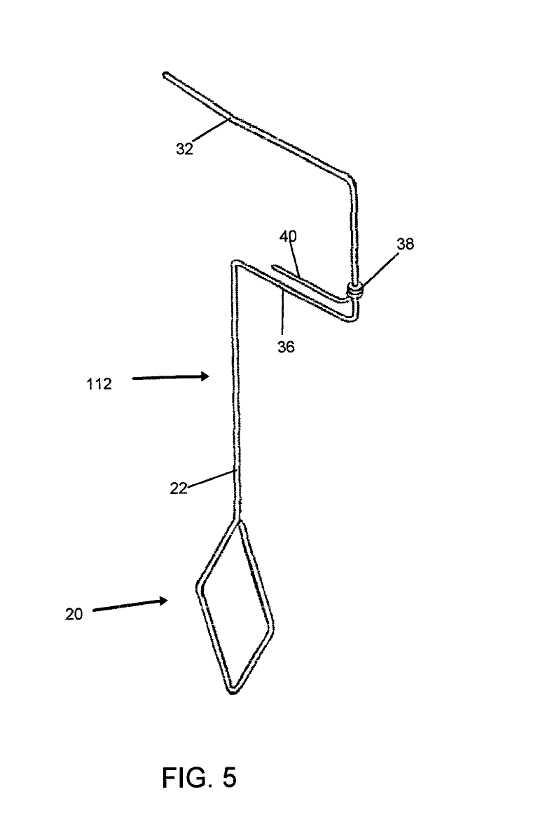

FIG. 5 shows a modification, indicated generally by reference numeral 112, of the rod 12 of FIGS. 1 through 4 and, for convenience, parts of the rod 112 which correspond to those of the rod 12 are indicated by the same reference numerals and are not described further.

In the rod 112, the angle portion 24 is replaced by a horizontal portion 36 extending from the top of the intermediate portion 12 and by a vertical portion 38 extending between the horizontal portion 26 and the top end portion 32.

In this case, since the rear of the sign 14 does not rest against the angle portion 24 of the rod 12 of FIGS. 1 through 4, a signboard retainer in the form a length of metal rod 40 is twisted at one end to form coils 42 extending around the vertical portion 38 and, thereby, securing the signboard retainer rod 40 relative to the rod 112.

In use, the signboard retainer 40 is inserted into one of the openings 18 of the signboard 14 to prevent the signboard 14 from flapping around the top end portion 32. Displacement of the sign 14 along the top end portion 32 is, however, again resisted by the friction engagement of the top end portion 32 with the wall of the respective opening 18 as described above with reference to FIG. 3.

As will be apparent to those skilled in the art various modifications may be made in the above-described embodiments of the present invention within the scope of the appended claims.

What is claimed is:

1. A sign, comprising a length of metal rod bent at a lower end thereof to provide a ground or soil penetration tip, a vertical portion extending upwardly from said tip, a further angled portion extending upwardly from said vertical portion and a top end portion extending substantially horizontally from an upper end of said further portion, said sign further comprising a signboard and said signboard having a horizontal top edge and a horizontally extending opening in the vicinity of said top edge, said top end portion extending along said opening and said top end portion including a bent portion intermediate opposite ends thereof, such that said opposite ends and said bent portion frictionally engage said signboard at locations which are diagrammatically opposite and longitudinally spaced relative to said top end portion.

2. A sign as claimed in claim 1, wherein said signboard comprises plastic-coated corrugated cardboard.

3. A sign as claimed in claim 1, wherein said tip is diamond-shaped.

4. A sign as claimed in claim 1, wherein said tip, said vertical portion, said further portion and said top end portion are co-planar, whereby said metal rod is flat.
